(19) United States
(12) Patent Application Publication
(10) Pub. No.: US 2005/0039256 A1
(43) Pub. Date: Feb. 24, 2005

(54) Floor level lift for physically challanged individuals

(76) Inventors: Forest S. Price, New Ulm, TX (US); Barrett L. Tillison SR., Houston, TX (US)

Correspondence Address: W. ALLEN MARCONTELL, P.O. BOX 800149, HOUSTON, TX, 77280-0149, US

(21) Appl. No.: 10/644,336

(22) Filed: Aug. 20, 2003

(51) Int. Cl. A61G 7/10

(52) U.S. Cl. 5/86.1; 5/81.1 R

(57) ABSTRACT

A method and apparatus is described as having the useful purpose of assisting ambulatory infirm individuals to their feet from a floor level posture when non-injurious falls are experienced. A mast guided seat that is translated along the mast by a D.C. motor driven linear actuator is supported on a wheeled frame for convenient movement by a care-giving party to proximity with a downed individual. The seat is capable of a floor contacting position. As the seat approaches the floor, a wheel breaking mechanism is engaged to prevent further movement of the machine along the floor as the user mounts the seat.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1.Field of the Invention

This invention includes a machine and method for aiding caregivers of the ambulatory infirm. In particular, the invention comprises a device and procedures for assisting a person that is capable of self-support and limited mobility but incapable of rising from a floor surface to a standing position.

2. Description of Related Art

The prior art is replete with hoists for lifting and transporting invalids. The disclosures of U.S. Pat. No. 6,430,761 to Alexander Brandorff et al; U.S. Pat. No. 6,367,103 to Nicholas Collins; U.S. Pat. No. 6,289,534 to Reza Hakamiun et al; U.S. Pat. No. 5,802,633 to Guido Capaldi; and U.S. Pat. No. 4,633,538 to David R. James et al are representative. Of predominate concern to this prior art has been provision of a device to remove an invalid from a bed or transfer an invalid from a wheel chair to a bed.

While there is a great need for machines to assist the invalid and incapacitated, the prior art has not adequately addressed the needs of the ambulatory infirm. The ambulatory infirm are those individuals having impaired mobility due to age or injury but are nevertheless able to stand erect and walk. Often, however, the mobility impediments of such individuals also preclude an ability to raise oneself from a floor surface to the erect position. In the normal course of movement, such individuals rise to standing from an intermediate platform such as a chair or bedside. From an intermediate platform, the individual may shift their primary body weight from the intermediate platform surface directly onto their legs and feet. When rising from a floor surface, however, other muscle and skeletal systems must be used to achieve the erect posture.

An unimpaired person will usually regain erect posture from the prone position by first rising to a kneeling position. This places much of the body weight directly on one or both knees. Unfortunately, due to arthritis or injury, any weight or pressure on the knees of many individuals among the ambulatory infirm is extremely painful. The most the care-receiver can achieve for themselves or with immediately present assistance, is a sitting position with a generally erect torso and buttocks on the floor surface.

The circumstance giving rise to a need for the present invention that is most familiar to our society includes the presence of a care-giving assistant such as a spouse, nurse or personal assistant. In the case of a care-giving spouse, the care-giver may be as incapacitated as the care-receiver i.e. one ambulatory infirm individual is aiding another ambulatory infirm individual. Specifically, the strength to lift a care-receiver directly from a floor surface to their feet is often beyond the care-giver's capacity. Hence, when the care-receiver falls or is unseated in some manner, third party assistance must be called to restore the fallen to their feet.

It is an objective of the present invention, therefore, to provide the ambulatory infirm a device that will assist them to regain their feet from a sitting position on a floor surface.

Another object of the present invention is a personal lifting device that is sufficiently light, mobile and may be manipulated by another ambulatory infirm individual.

### BRIEF SUMMARY OF THE INVENTION

These and other objects of the invention as will become apparent from the detailed description to follow are served by a personal assistance apparatus supported from a wheeled, H-shape base frame. The assistance apparatus comprises a mast having its axis set at a small angle, 5° from vertical, for example, to confine translation of a bucket type seat in both directions along the mast axis. In the presently preferred embodiment, seat translation along the mast is driven by a parallel axis linear actuator that is energized by an electric motor. Elements are aligned to allow the seat to be driven down the mast to floor contact. As the seat approaches floor contact, a follower mechanism activates a braking mechanism to immobilize the apparatus support wheels. Such immobilization of the support wheels provides resistance to external forces imposed by an infirm users efforts to enter the seat.

Low sidewalls and padded arm rests on the lift apparatus seat provide the infirm user a convenient support and fulcrum to position their posterior into the seat confines. More importantly, the arms provide important test obstacles to a residual ability to stand or walk. A person that cannot manipulate themselves onto the floor-level seat surface between the lateral arm barriers, probably cannot or should not be attempting to stand or walk. The very reason for the fall, or as a consequence of the fall, may be a structural failure in the body of the fallen person. Any forced attempt to return the fallen person to their feet could seriously exacerbate the original injury.

A battery powered motor that is controlled by a console or switch module that is accessible to the infirm user gives the user an option to personally control the rate the seat rises and lifts the user.

### BRIEF DESCRIPTION OF THE SEVERAL VIEWS OF THE DRAWINGS

The invention is hereafter described in detail and with reference to the drawings wherein like reference characters designate like or similar elements throughout the several figures and views that collectively comprise the drawings. Respective to each drawing figure:

FIG. 1 is a pictorial view of the invention;

FIG. 2 is a side elevation view of the invention with the seat at a floor engagement position;

FIG. 3 is a backside elevation view of the invention with the seat at a floor engagement position;

FIG. 4 is a plan view of the invention;

FIG. 5 is a sectioned elevation view of the invention;

FIG. 6 is a side elevation view of the invention with the seat at a raised position;

FIG. 7 is a backside elevation view of the invention with the seat at a raised position; and,

FIG. 8 is a schematic of the braking mechanism.

### DETAILED DESCRIPTION OF THE INVENTION

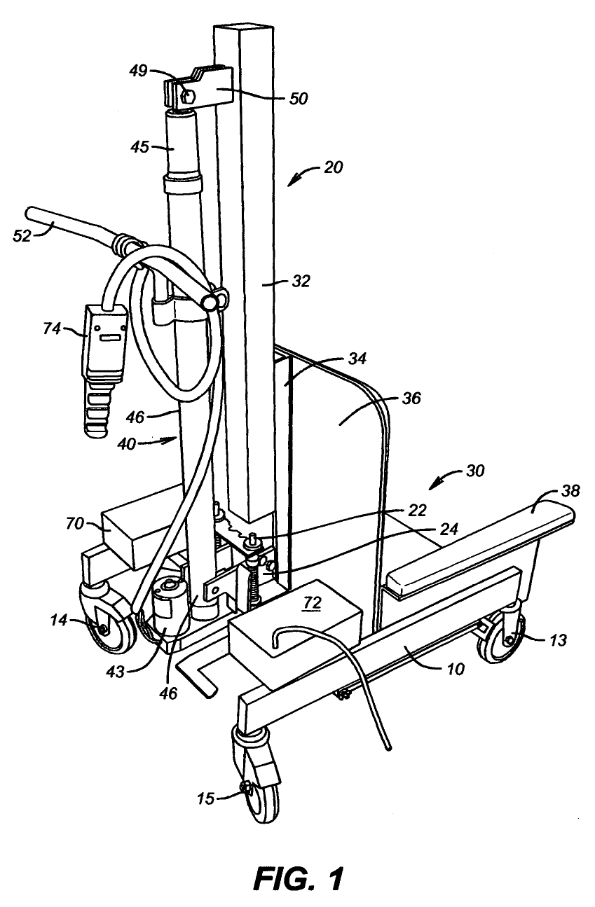

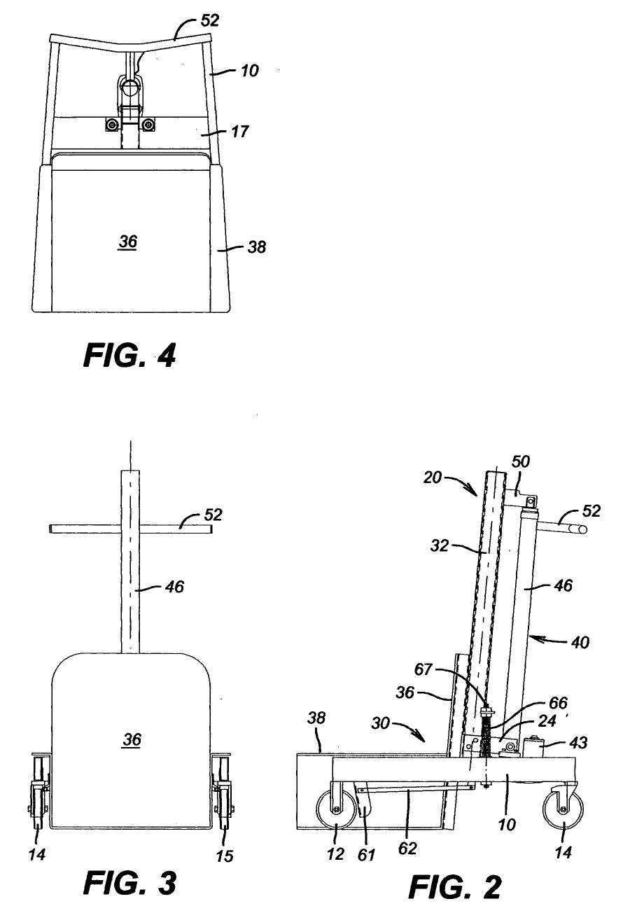

Referring to FIGS. 1 through 4, a presently preferred embodiment of the invention comprises a substantially H-shaped base frame 10 supported by four wheels 12, 13, 14 and 15. The front wheels 12 and 13 may have a fixed rotational plane whereas the rear wheels 14 and 15 are preferably castered about a substantially vertical axis.

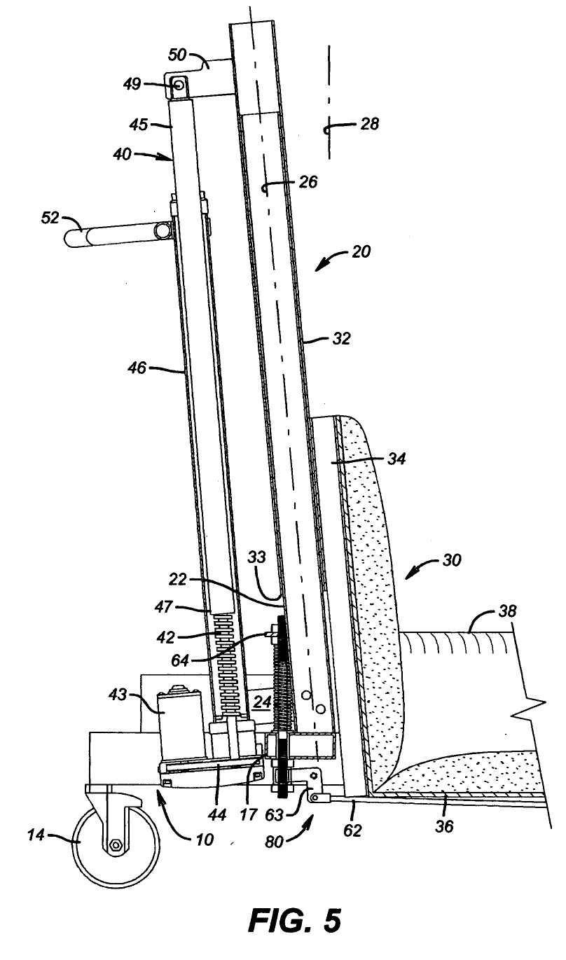

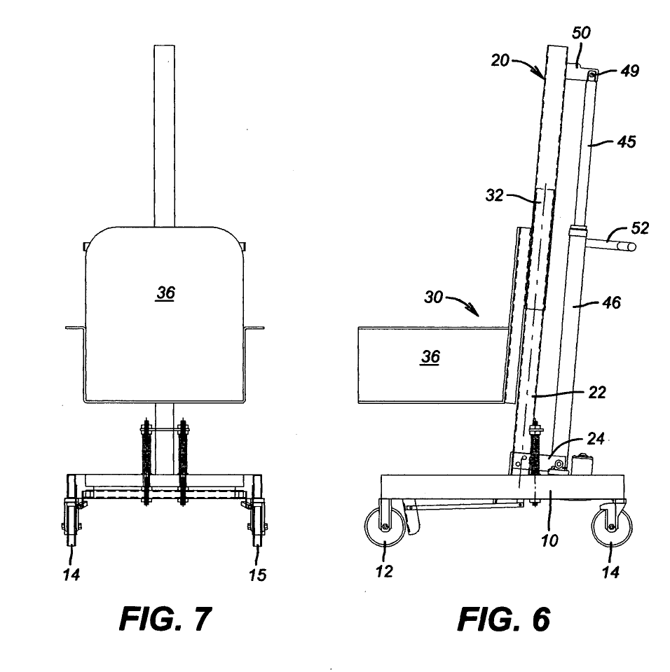

A mast assembly 20, shown in sectioned elevation by FIG. 5, comprises a fixed column 22 of square or rectangular steel tubing stock that is secured at its lower end by welding and/or bolted flanges 24 to the cross member 17 of the base frame 10. This fixed column 22 serves as a guide and support track for the seat assembly 30. The longitudinal axis of column 22 is preferably set at a convenient angle, 5° for example, to the vertical plane 28. Such inclination of the column axis 26 increases the apparatus stability as the loaded seat 36 is raised. As the seat load rises along the column 22, the seat load center translates toward the apparatus center of gravity. Additionally, sliding friction between the fixed column 22 and the seat carrier sleeve 32 is minimized by a correspondingly minimal deflection of the column.

The seat carrier sleeve 32 is preferably configured for a close sliding fit over the fixed column 22 for telescoped translation along the fixed column length. Secured to the seat carrier sleeve 32 is a seat mounting bracket 34. The seat mounting bracket 34 provides a direct attachment interface for the seat structure 36.

Seat translation force is applied by a linear actuator assembly 40. In a presently preferred embodiment of the invention, the actuator assembly 40 comprises a threaded drive shaft 42 that is rotationally powered by a D.C. electric motor 43 via a belt or chain driven transmission 44. The rotating drive shaft is preferably confined within a shaft housing 46. Those of ordinary skill in the art will recognize the obvious alternative utility of a direct gear drive or worm drive transmission between the motor 43 and the drive shaft 42.

Telescoping within the shaft housing 46 is an actuator tube 45 having a cooperatively threaded chase ring 47 meshed with the shaft 42 threads. An upper end of the actuator tube 45 is secured by means of a clevis pin 49, for example, to a load bracket 50. The load bracket 50 is an integral projection from the seat carrier sleeve 32 and thereby serves as a force application point on the carrier sleeve 32. As the actuator tube 45 is axially translated along the drive shaft 42 by motor driven rotation of the drive shaft, the carrier sleeve 32 and seat 36 are translated correspondingly.

Although hydraulic or chain mechanisms may be used for translating the seat assembly 30, a screw driven linear actuator is preferred due to inherent safety. A selected screw pitch will prevent the possibility of a “free fall” of the seat assembly in the event of a power failure.

Also secured to the drive shaft housing 46 is a handlebar manual control 52 for convenient control and rolling transport of the apparatus over a substantially flat floor surface.

Primary energy for the low voltage (12v) D,C, motor 43 may be derived from a battery pack 70 secured to the base frame 10. A charger and controller unit 72 may be secured to the opposite side of the base frame 10. A tethered control console 74 may provide a direct interface between the invention power features and the operator who may be either a care-giver or a care-receiver.

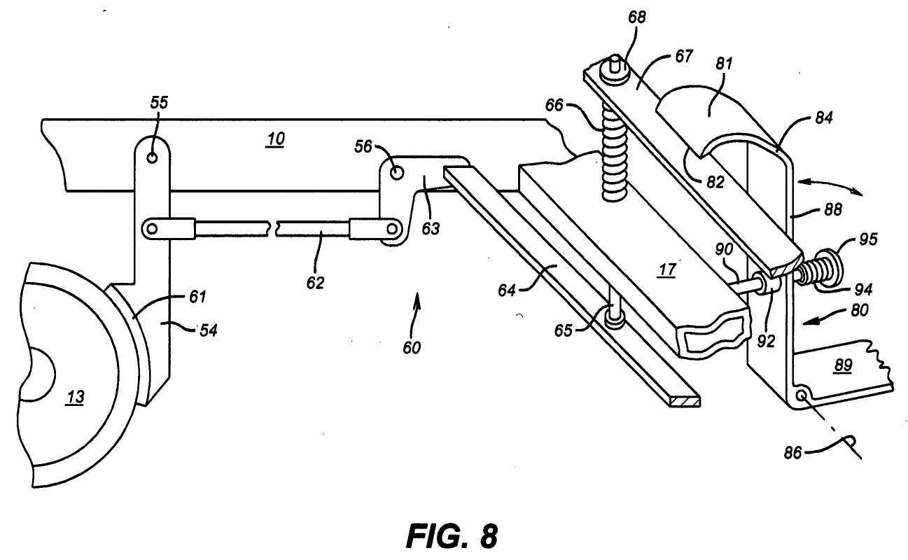

As the descending seat 36 approaches the supporting floor surface, a wheel braking system 60 is engaged to prevent the unit from moving due to the care-receiver's manipulations into the seat. A simple but effective brake assembly 60 is represented by the schematic of FIG. 8 which comprises a friction shoe 61 respective to each front wheel 13 and 14. The schematic of FIG. 8 illustrates only wheel 13 but the elements shown are to be understood as duplicated on the opposite side of the apparatus respective to wheel 12.

The friction shoes 64 are secured to respective shoe carriers 54. The shoe carriers are pivotally secured at 55 to the frame 10. Also pivotally connected to each shoe carrier 54 is one end of a link rod 62. The opposite end of each link rod is pivotally secured to the driven arm of a bell crank 63. The bell crank 63 is pivotally secured at 56 to a frame element 10.

The driving arm of each bell crank 63 is pivotally attached to opposite ends of the same transverse load bar 64. A pair of transversely spaced load rods 65 are secured to a lower load bar 64 and extend upwardly through aligned apertures in the base cross member 17. The penetration of the cross member 17 by the load rods 65 is axially unrestrained.

Above the cross member 17, the load rods 65 are structurally connected by an upper load bar 67. Threaded assembly components 68 above and below the upper load bar 67 provide means to adjust the special separation between the upper face of the cross member 17 and the lower face of the upper load bar 67.

Upward penetration of the load rods 65 through the cross member 17 is limited by a thread abutment (not shown) on the load rods 65. Axial displacement of the load rods is biased against the threaded abutment by coiled springs 66. The threaded abutment is adjusted to set an optimum position of shoe 61 disengagement from the surface of wheels 12 and 13. Such shoe disengagement is resiliently sustained by the bias of springs 66.

The schematic of FIG. 8 illustrates the break assembly 60 at the shoe engaged position where the wheels 12 and 3 are restrained from rotating. This engaged position is imposed by the lower edge 33 of the seat carrier sleeve 32 as it bears against the upper load bar 64 when the descending seat 30 approaches floor level.

At the point that the shoes 61 are firmly set against the wheels 12 and 13, the upper load bar 67 passes the abutment edge 82 of a break retainer assembly 80. The break retainer assembly comprises a bell crank pivoted strap 84 that may be pivotally anchored about the axis 86. The vertical leg 88 of the bell crank is terminated by a hook feature 81. A horizontal leg 89 of the assembly 80 is a break release tab.

A retaining rod 90 secured to the frame cross member 17 freely penetrates an aperture in the vertical leg 88. A threaded abutment 92 sets an angular limit position of the vertical leg 88 about the axis 86. A coiled compression spring 94 between the vertical leg 88 surface and a rod terminus 95 exerts a standing rotational bias on the assembly 80 toward the abutment 92. As the upper load bar 67 is displaced by a descending seat carrier sleeve 32, the outer edge of the upper load bar 67 engages the sloped face of the bell crank hook feature 81 on the break retainer assembly. This engagement rotates the bell crank 84 about the axis 86 against the bias of spring 94 until the upper face of the load bar 67 passes below the hook abutment edge 82. At this point, the spring 94 bias restores the bell crank against the abutment 92 and latches the load bar 67 at the brake engaged position.

The brake engagement is maintained by the brake retainer assembly 80 after the edge 33 of the seat carrier sleeve 32 is raised above and off the upper load bar 67. Brake release is obtained by manually applied force on the release tab 89 which rotates the bell crank 84 against the bias of spring 94 and displaces the hook abutment 82 from the operating plane of load bar 67. With the hook abutment removed, the bias of break release spring 66 pulls the break shoes 61 from engagement with the wheels 12 and 13.

Having described the mechanical elements and assembly of the invention, the following example may represent a typical procedure of the invention in use. In the frequent case of an elderly couple, one is unseated or falls to the floor. Although the fallen one is capable of walking, he or she is incapable of regaining their feet from the floor. Correspondingly, the mobile spouse is physically incapable of assisting the fallen spouse to their feet.

Responsive to the predicament, the mobile spouse seeks out the present invention and by the handle bars 52, pushes the machine to the fallen spouse. On this score, It should be recognized that the present apparatus may be constructed to dimensions compatible with passing through interior portals. A machine having the capacity to lift a seat load of 350 pounds may be constructed to weigh less than 100 pounds. Hence, little physical effort is required to roll the machine: an essential characteristic for a machine to be used by a spousal pair of ambulatory infirm individuals.

With the fallen spouse sitting erect, buttocks on the floor, the machine is aligned closely behind the fallen spous and the seat 36 lowered to the floor by the tethered control console 74. As the seat 36 approaches floor contact, the brake assembly 60 engages the wheels 12 and 13 to firmly secure the machine position on the floor.

The fallen spouse next manipulates him or herself into the seat 36 using their arms and elbows on the padded arms 38 of the seat. The ability and capacity of the fallen spouse to manipulate themselves into the seat is a strong indication of their ability to maintain their feet and walk after their fall. A critical bone fracture injury, for example, will become painfully apparent from such manipulations. Although the invention seat 36 could be constructed without the arms 38 to allow a person to roll or be rolled onto the seat, it is possible that by doing so, any injuries that caused or arose from the fall may be exacerbated by an attempt to stand. Hence, the seat arms 38 offer test obstacles to the wisdom of attempting to stand after a fall.

Once the fallen spouse has managed to position themselves on the seat 36 they may, at this point, take possession of the control console 74 and command the motor 43 to drive the actuator assembly 40 along the seat lifting direction. When the seat 36 has risen to a comfortable level and the fallen spouse has assessed their physical condition, they may exit the seat by shifting their body weight to their feet in a normal motion.

A point has been made of the importance that the seat arms 38 may have upon the safe usage of the invention. Recognition of this safety characteristic does not preclude constructions of the invention without such seat arms or with selectively removed arms.

Non-illustrated embodiments of the invention having no arms or removable arms for the load platform (seat) 30 may be given household and light industrial uses and utilities beyond lifting duties for the ambulatory infirm. One example of such household utility may be as a powered step platform for reaching high shelves and cabinets. An example of light industrial use may be the placement and removal of 100+ pound stock in a lathe. Both examples may require a load platform that is positioned substantially level with the supporting floor surface but is also immobilized along that floor surface when load is deposited on or discharged from the platform.

While preferred embodiments of the invention have been shown and described, modifications thereof may be made by those skilled in the art without departing from the spirit or teaching of the invention. The embodiments described herein are exemplary only and are not intended as limiting or exclusive. Many variations and modification of the invention are possible and obvious to those of ordinary skill in the art. Accordingly, the scope of protection is not limited to the embodiments described herein, but is limited only by the following claims, the scope of which shall include all equivalents of the subject matter of the claims.

1-18. (Cancelled)

19. A personal assistance apparatus comprising: a base frame supported from a floor surface by a plurality of wheels distributed around the perimeter of an interior area; a linear actuator having a translation axis secured to said base frame at an alignment position with said base frame for substantially normal intersection of said axis with said floor surface within said interior area; and, a load platform having a seat plane secured to said linear actuator for selective translation to and from a low position that is substantially within said interior area and where said seat plane is substantially contiguous with said floor surface.

20. A personal assistance apparatus as described by claim 19 wherein said linear actuator is inclined to a vertical plane for translation of a rising load upon said platform toward an apparatus center of gravity.

21. A personal assistance apparatus as described by claim 19 wherein the axis of said linear actuator is inclined to a vertical plane at about 5° for translation of a rising load upon said platform toward an apparatus center of gravity.

22. A personal assistance apparatus as described by claim 19 having a wheel braking mechanism for restricting rotation of at least one of said wheels, said braking mechanism being resiliently biased to a wheel disengagement position.

23. A personal assistance apparatus as described by claim 22 wherein said braking mechanism is operated to restrict wheel rotation by a brake engagement element of said linear actuator.

24. A personal assistance apparatus as described by claim 23 wherein said breaking mechanism comprises a brake linkage that is engaged against a resilient bias by a structural portion of said linear actuator.

25. A personal assistance apparatus as described by claim 24 wherein said structural portion of said linear actuator is positioned on said linear actuator to engage said brake linkage as said seat plane approaches said floor surface.

26. A personal assistance apparatus as described by claim 25 having a retainer mechanism to continue engagement of said breaking mechanism with said wheel against said resilient bias after said linear actuator withdraws said seat plane from said floor surface.

27. A mobile lifting device having a base frame supported from a floor surface by a plurality of wheels distributed around the perimeter of an interior area, a linear actuator having a translation axis secured to said base frame at an alignment position with said base frame for substantially normal intersection of said axis with said floor surface within said interior area and a load platform having a load support plane secured to said linear actuator for selective translation to and from an low position that is substantially within said interior area and where said load support plane is substantially contiguous with said floor surface.

28. A mobile lifting device as described by claim 27 wherein said linear actuator is inclined to a vertical plane for translation of a rising load upon said platform toward an apparatus center of gravity.

29. A mobile lifting device as described by claim 27 wherein the axis of said linear actuator is inclined to a vertical plane at about 5° for translation of a rising load upon said platform toward an apparatus center of gravity.

30. A mobile lifting device as described by claim 27 having a wheel braking mechanism for restricting rotation of at least one of said wheels, said braking mechanism being resiliently biased to a wheel disengagement position.

31. A mobile lifting device as described by claim 30 wherein said braking mechanism is operated to restrict wheel rotation by a brake engagement element of said linear actuator.

32. A mobile lifting device as described by claim 30 wherein said breaking mechanism comprises a brake linkage that is engaged against a resilient bias by a structural portion of said linear actuator.

33. A mobile lifting device as described by claim 32 wherein said structural portion of said linear actuator is positioned on said linear actuator to engage said brake linkage as said seat plane approaches said floor surface.

34. A mobile lifting device as described by claim 33 having a retainer mechanism to continue engagement of said breaking mechanism with said wheel against said resilient bias after said linear actuator withdraws said seat plane from said floor surface.

35. A mobile lifting device as described by claim 34 wherein said retainer mechanism is manually operated to release said breaking mechanism from engagement with said wheel.
